(19) United States
(12) Patent Application Publication
(10) Pub. No.: US 2005/0099361 A1
(43) Pub. Date: May 12, 2005

(54) Foldable display/screen for portable electronic devices

(76) Inventor: Vladimir Majer, Zagreb (HR)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/951,284

(22) Filed: Sep. 27, 2004

Related U.S. Application Data
(63) Continuation of application No. PCT/HR02/00024, filed on Apr. 15, 2002.

(30) Foreign Application Priority Data
Mar. 27, 2002 (HR) P20020257A

(51) Int. Cl. G09G 5/00

(52) U.S. Cl. 345/1.3

(57) ABSTRACT

A foldable and unfoldable display/screen for portable electronic devices is provided for the visual presentation of electronic signals, information, pictures or data that are produced, processed, transferred or received by the portable electronic device.

### 1. FIELD OF TECHNICS THAT CONCERNS THE INVENTION

This invention is related to the field of technics that is concerned with devices, which optical work is modified by changing the optical properties of the device medium or of the configuration for controlling the intensity, color, phase, polarisation or direction of the light, and it is classified according to the international patent classification (IPC) as G02 F.

### 2. TECHNICAL PROBLEM

One of the greatest problems of the present state of technics concerning the portable electronic devices (mobile telephones, portable computors/laptops and alike) is the presentation of the information on the display/screen of sufficient size in a way that the user can see the presented informations in a sufficiently acceptable way. That means, that the problem concerning the relation between the size of the display/screen and the size of the portable device arises. According to the present state of the technology of the portable devices, particularly in relation to the further development and minimisation of hardware that processes the informations, it comes to that the biggest volume part of the device hardware part is exactly the display/screen. If the display/screen is reduced to the size of the device hardware part that processes the informations, it results in such a small display/screen where only the basic informations being visually recognisable to the user can be presented. Due to that problem it comes to the paradox, that the volume hardware part of the portable electronic device can process a great amount of informations, but the problem of presenting these informations on the display/screen arises. If to that small hardware part of the portable electronic device a big display/screen is added, in order to present all the processed informations, then a big portable electronic device is obtained, and if the display/screen is reduced to the size of the hardware part of the portable electronic device, then the user has a difficulty with the visual size of the presented informations. For the user also the problem of the access possibility to the standard picture on the Internet appears where the width to the height ratio makes 4:3. This ratio also determines the size of the display of the portable electronic device if someone wants to use the present standard web site on the Internet without any special alterations of the pictures. But this ratio determines that, in case when someone wants to present a visually recognisable picture in that ratio, the display becomes much bigger than the hardware part of the device itself, and again the above described problem and disproportion arises.

### 3. STATE OF THE ART

Numerous solutions for avoiding the problem described in preceeding section 2 are proposed. But, they are all based on the principle, that the information or picture on the portable electronic devices—mobile telephone, little PC computor, WEB PDA device or ordinary PDA device, is presented on one display/screen.

### 4. EXPOSURE OF THE INVENTION ESSENCE

The primary goal of the invention is to present visually the electronic signals, informations, pictures or data that are produced, processed, transferred or received by the portable electronic device on two or more displays/screens that can be folded or unfolded, where the entire width of all individual displays/screens is related to the entire width of all individual displays/screens by the ratio 4:3 of the entire picture.

The secondary goal of the invention is to enable by means of such foldable and unfoldable display/screen the production of portable electronic devices—mobile telephones, small PC computers, WEB PDA devices, ordinary PDA devices and alike, which will have for the user an optimal and acceptable relation between the size of the device hardware part that produces, processes, transfers or receivs the electronic signals, informations, data or pictures and the size of the display/screen that presents these informations.

The further goal of the invention is to enable to the portable (mobile) telephones the visual presentation of the standard Internet web sight on two or more displays/screens, which can be folded and unfolded, at the width to height ratio 4:3 of the entire picture.

The additional goals and advantages of the invention will partly be presented in the invention description that follows, and partly will be considered through the invention application.

The visual presentation on two or more displays/screen according to this invention comprises the electronic signals, informations, pictures or data that are produced, processed, transferred or received on the portable electronic device and can be visually presented on two or more displays/screens that can be folded or unfolded, where the dimensions of the individual display/screen within the complexes of two or more displays/screens that are foldable and unfoldable along the horizontal axis (along width a of the display/screen) are determined by formula (1) b=[(a:4)×3]:n, where a=active width of the individual display/screen, b=active height of the individual display/screen, n=number of individual displays/screens. The dimensions of the individual display/screen within the complex of two or more displays/screens that are foldable and unfoldable along the vertical axis (along height b of the display/screen) are determined by formula (2) c=a:n, where c=active width of the individual display/screen, a=total active width of all displays/screens, n=number of individual displays/screens, and by formula (3) b=(a:4)×3, where b=active height of the individual displays/screens, a=total active width of all displays/screens. The dimensions of individual displays/screens within the complex of several displays/screens that are foldable and unfoldable along both several vertical and several horizontal axes within one complex are determined by formula (4) (a×n):(b×n)=4:3, where a=active width of the individual display/screen, b=active height of the individual display/screen, n=number of individual displays/screens. The total active width of all individual displays/screens is related to the total active height of all individual displays/screens, regardless to the number of displays/screens and regardless to the horizontal or vertical folding axis, by the ratio 4:3, where the unfolded displays/screens together present the electronic signals, informations, data or pictures that are produced, processed, transferred or received in the portable electronic device in the width to height ratio 4:3 of the entire picture, where the electronic signals, informations, pictures or data that are produced, processed, transferred or received in the portable electronic device are divided by the hardware and/or software into as many individual parts of the whole as many there are displays/screens, where each of these individual parts of the whole of the electronic signals, informations, pictures or data is presented separately on one of the displays/screens, where the work of the individual displays/screens is controlled by the today already standardly known and accessible hardware and software, where such divided parts of the electronic signals, informations, pictures or data on all displays/screens make together an integrated presentation of the electronic signals, informations, pictures or data, where the folded displays/screens can be unfolded in several interconnected parts. The size and number of displays/screens that can be folded and unfolded according to this invention is not limited by anything but only by the technological realisation possibilities and by the needs of the user. For the visual presentation of the electronic signals, informations, pictures or data according to this invention the already existing or some future new developed hardware or software can be used.

### 5. SHORT DESCRIPTION OF DRAWINGS

The enclosed drawings that are included in the description of the invention illustrate the best invention realisation way at present and help at explaining the basic principles of the invention.

FIG. 1. is the front view of the display/screen, where all essential parts of the invention are presented—in Detail X two displays/screens that can be folded and unfolded, with the view of the active part of the display/screen, the protection cover of the display/screen and with the connecting cable are presented. On both displays/screens a part of the divided geometrical shape of a circle is presented. In detail Y the standard display/screen of width a to height b ratio 4:3 is presented, and also the geometrical shape of the circle is presented.

FIG. 2. is the side view of the display/screen, where the essential parts of the invention—two displays /screens that can be folded and unfolded, the protection cover of the display/screen, the connecting cable and the portable electronic device—are presented.

FIG. 3. is the perspective presentation, where the essentail parts of the invention are presented—the folded dispalys/screens, where one of them makes with the portable electronic device one complex whole.

FIG. 4. is the perspective view, where the essentail parts of the invention are presented—the view of the portable electronic device, where one display/screen is set at an angle of 90° with respect to the other display/screen.

FIG. 5. is the perspective view, where the essentail parts of the invention are presented—the view of the portable electronic device, where one display/screen is set at an angle of 180° with respect to the other display/screen.

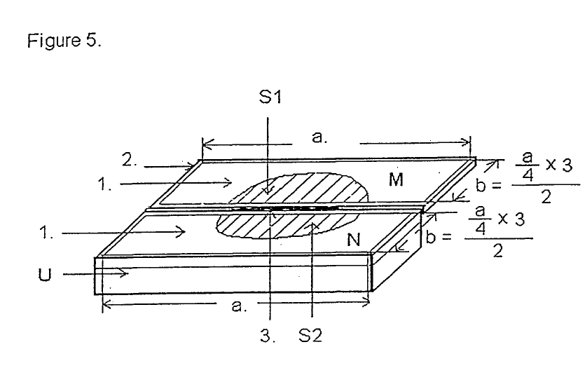

FIG. 6. is the presentation of the front view and the perspective view of three various invention realisations, where the essentail parts of the invention are presented—the view of the portable electronic device with several displays/screens that can be folded or unfolded along the vertical or horizontal axis, where one of the displays/screens makes together with the portable electronic device one complex whole.

FIG. 7. is the front view presentation and the perspective view of three various invention realisations, where the essential parts of the invention are presented—the view of the portable electronic device with several displays/screens that can be folded or unfolded along the vertical or horizontal axis, or along both vertical and horizontal axis, where none of the dispalys/screens is connected with the portable electronic device in one complex whole, but at least one display/screen is connected to the portable electronic device by means ofthe cable or in some other way.

### 6. DETAILED DESCRIPTION OF FOUR INVENTION REALISATION WAYS

Now it will be referred to the details of this anticipated invention realisation, which examples are illustrated by the enclosed drawings.

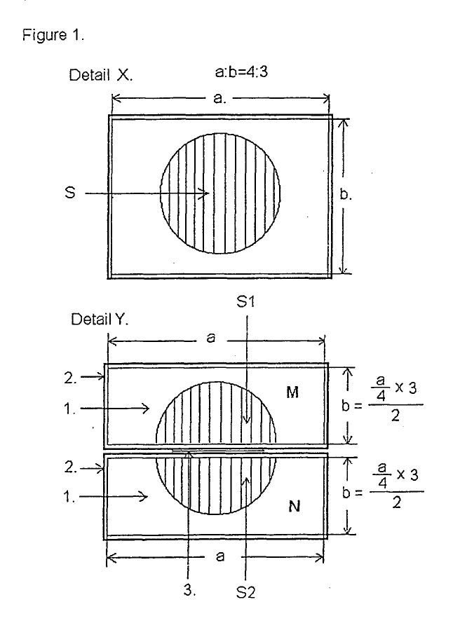

According to the invention and referring to FIG. 1 it can be seen that for the first realisation way of the invention FOLDABLE DISPLAY/SCREEN FOR PORTABLE ELECTRONIC DEVICES, for the complex consisting of two displays/screens that are foldable and unfoldable along the horizontal axis (along width a of the display/screen) it is necessary the standard display/screen, which width a to heigh b ratio makes 4:3 what is shematically presented in Detail X, FIG. 1 on which the schematic shape of circle S is presented, to divide horizontally into two displays/screens M and N, where width a of display/screen M or N is related to height b of display/screen M or N by formula (1) b=[(a:4)×3]:n, where a=active width of the individual display/screen, b=active height of the individual display/screen, n=number of individual displays/screens (in this case 2), and which are connected by cable 3 or in some other suitable way, as it is presented in Detail Y, FIG. 1. On display/screen M in active field 1. that is inside protection cover 2. upper half S1 of the schematic shape of circle S according to formula (1) b=[(a:4)×3]:n is presented, and on display/screen N in active field 1. that is inside protection cover 2. lower half S2 of the schematic shape of circle S according formula (1)b=[(a:4)×3):n is presented. In such a way, as it can be seen on Detail Y, FIG. 1, the entire schematic shape of circle S presented on Detail X FIG. 1 is divided in two parts along the horizontal axis and presented in two parts on two separate displays/screens M and N. The division of electronic signals, informations, pictures or data on two displays/screens is controlled by the today already standardly known and used hardware and software with the possibility of applying, in future, newly developed hardware and software, where such divided parts of electronic signals, informations, pictures or data are presented on two separate displays/screens, but viewed together on both displays/screens they make an integral presentation of electronic signals, informations, pictures or data, as it is presented by the example of dividing the schematic shape of circle S.

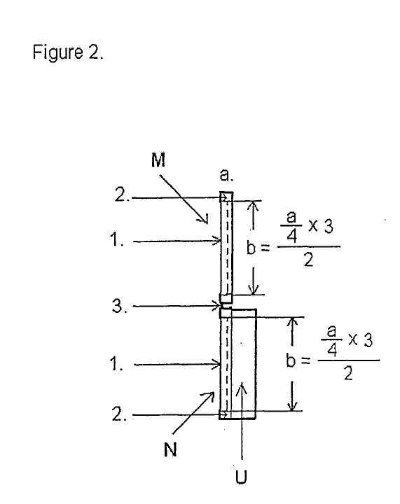

In accordance with the invention and referring to FIG. 2, the side view of FOLDABLE DISPLAY/SCREEN FOR PORTABLE ELECTRONIC DEVICES is presented, where it is visible that display/screen N is connected with the portable electronic device in one whole, and the other details correspond to the presentation and explanation according to FIG. 1 in the upper fragment.

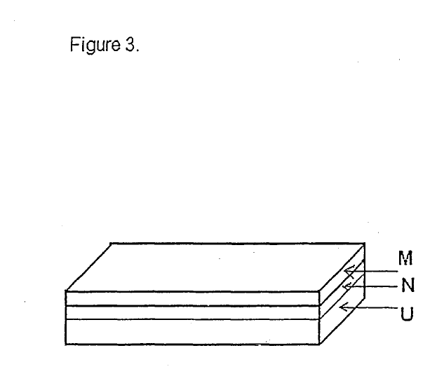

In accordance with the invention and referring to FIG. 3, the shematic appearance of portable electronic device U with display/screen M folded on display/screen N is presented in the perspective, and in such a way the portable eletronic device and the displays/screens make together one whole and a compact portable electronic device.

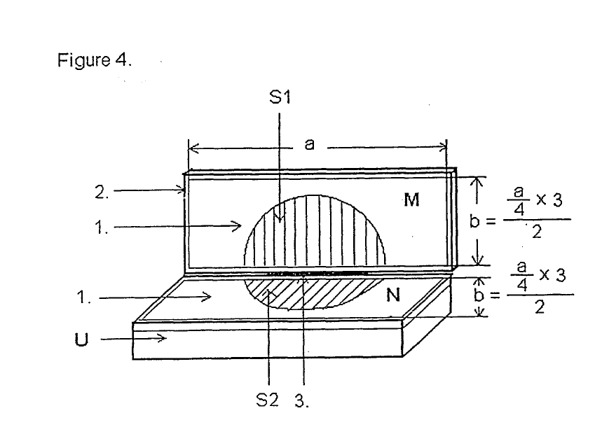

In accordance with the invention and referring to FIG. 4, the schematic appearance of portable electronic device U and display/screen M, which in this case is lifted at an angle of 90° with respect to display/screen N, is presented in the perspective.

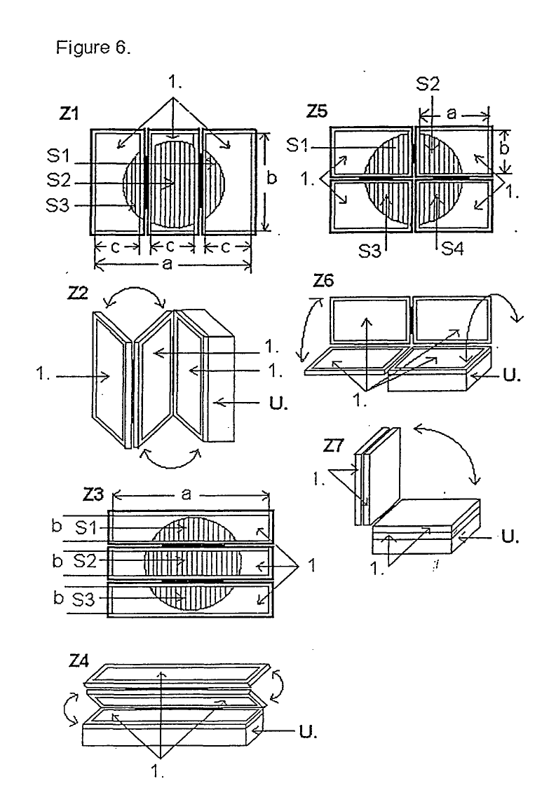

In accordance with the invention and reffering to FIG. 6, the schematic appearance of portable electronic device U and the way of folding and unfolding display/screen M, which in this case is opened at an angle of 180° with respect to display/screen N, is presented in the perspective.

In accordance with the invention and referring to FIG. 6 it is visible that for the second realisation way of the invention FOLDABLE DISPLAY/SCREEN FOR PORTABLE ELECTRONIC DEVICES, for the complex consisting of several displays/screens foldable and unfoldable along the vertical axis (along height b of the display/screen) it is necessary the standard display/screen, which width a to height b ratio makes 4:3 and which is shematically presented in Detail X FIG. 1 on which the schematic shape of circle S is presented, to divide vertically in two or more displays/screens, where width c of individual display/screen 1 is related to height b of individual display/screen 1 according to formula (2) c=a:n where c=active width of the individual display/screen, a=total active width of all displays/screen, n=number of individual displays/screens (in this case 3), and according to formula (3) b=(a:4)×3 where b=active height of the individual display/screen, a=total active width of all displays/screens. In such a way, as this is visible in detail Z1 FIG. 6, the entire schematic shape of circle S presented in Detail X FIG. 1 is divided in three parts along the vertical axis and presented in three parts S1, S2 and S3 on three separate displays/screens 1, what is schematically presented by the drawing in detail Z1 FIG. 6. The folding and unfolding way of display/screen 1 is presented in perspective in detail Z2 FIG. 6. From the presented in detail Z2 FIG. 6 it is visible in the perspective that one of the displays/screens together with the portable electronic device is joint in one whole. According to formula (2) c=a:n and formula (3) b=(a:4)×3, the complex consisting of several displays/screens foldable and unfoldable along the vertical axis can be folded or unfolded along as many vertical axes as many the user wishes it, and it consists of as many displays/screens as many the user wishes them.

In accordance with the invention and reffering to FIG. 6 it is visible that for the third realisation way of the invention FOLDABLE DISPLAY/SCREEN FOR PORTABLE ELECTRONIC DEVICES, for the complex consisting of three or more displays/screens foldable and unfoldable along the horizontal axis (along width a of the display/screen) it is necessary the standard display/screen, which width a to height b ratio makes 4:3 and which is shematically presented in Detail X FIG. 1 and on which the schematic shape of circle S is presented, to divide horizontally in three or more displays/screens, where width a of individual display/screen 1 is related to height b of individual display/screen 1 according to formula (1) b=[(a:4)×3]:n where a=active width of the individual display/screen, b=active height of the individual display/screen, n=number of individual displays/screens (in this case 3). In such a way, as it is visible in detail Z3 FIG. 6, the entire schematic shape of circle S presented in Detail X FIG. 1 is divided in three parts S1, S2 and S3 on three separate displays/screens 1, what is by the drawing presented in detail Z4 FIG. 6. The folding and unfolding way of displays/screen 1 is presented in the perspective in detail Z4 FIG. 6. From the presented in detail Z4 FIG. 6 it is visible in the perspective that one of the displays/screens together with the portable electronic device is joint in one whole. According to formula (1) b=[(a:4)×3]:n the complex consisting of several displays/screens foldable and unfoldable along as many horizontal axes as many the user wishes it, and it can consist of as many displays/screens as the user wishes them.

In accordance with the invention and referring to FIG. 6 it is visible that for the fourth realisation way of the invention FOLDABLE DISPLAY/SCREEN FOR PORTABLE ELECTRONIC DEVICES, for the complex consisting of several displays/screens foldable and unfoldable along one or more vertical and along one or more horizontal axis it is necessary the standard display/screen, which width a to height b ratio makes 4:3 and which is schematically presented in Detail X FIG. 1 and on which the schematic shape of circle S is presented, to divide horizontally and vertically into several displays/screens, which dimensions are determined according to formula (4) (a×n):(b×n)=4:3 where a=active width of the individual display/screen, b=active height of the individual display/screen, n=number of the individual displays/screens (in this case 4). In such a way, as it is visible in detail Z5 FIG. 6, the schematic shape of circle S presented in Detail X FIG. 1 is divided into two parts along the horizontal axis and into two parts along the vertical axis and presented in four parts S1, S2, S3 and S4 on four separate displays/screens 1, what is presented by the drawing in detail Z5 FIG. 6. From the presented in detail Z6 and Z7 FIG. 6. it is visible in the perspective that one of the displays/screens together with the portable electronic device is joined in one whole.

According to formula (4) (a×n):(b×n)=4:3 the complex consisting of several displays/screens foldable and unfoldable along one or several horizontal and along one or several vertical axes can be folded and unfolded along as many horizontal or vertical axes as many the user wishes it. The complex can consist of as many displays/screens as many the user wishes them.

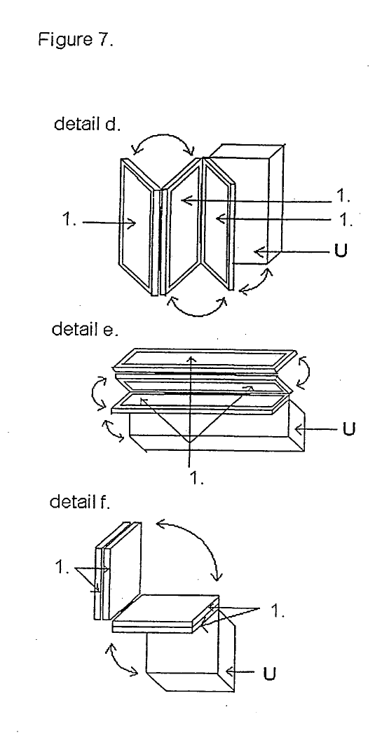

In accordance with the invention and referring to details d., e., f. in FIG. 7 the schematic appearance of portable electronic device U with the complex of several displays/screens foldable and unfoldable along several vertical axes in detail d. along several horizontal axes in detail e and along both the horizontal and vertical axis in detail f, where none of the displays with portable electronic device U is connected in one whole but one or several displays/screens 1 is connected with portable electronic device U by means of the cable or in some other way.

In accordance with the invention and referring to FIGS. 1 and 6 the total active width of all individual displays/screens is related to the total active height of all indivisual displays/screens by the ratio 4:3 regardless to the number of displays/screens and regardless to the number of horizontal and vertical folding axes. The division of the electronic signals, informations, pictures or data into several individual displays/screens is controlled by the today already standardly known and used hardware and software with the possibilitiy of applying in the future a newly developed hardware or software, where such divided parts of electronic signals, informations, pictures and data are presented on several displays/screens, but watched together on several displays/screens they make an integral presentation of the electronic signals, informations, pictures or data, as it is presented by the example of the schematic shape of circle S.

### 7. INVENTION APPLICATION WAY

In such a way the invention enables by means the portable electronic device the presentation of the electronic signals, informations, pictures or data on a much greater dimension of the display/screen than the dimension of the portable electronic device itself. In the same time, by folding the display/screen the required small total dimensions of the portable electronic device and the display/screen as a whole are obtained. That elliminates the present disproportion between the lesser size of the present and fiture portable electronic devices and their possibility of presenting the electronic signals, informations, pictures and data on an adequate display/screen.

It will be obvious to the experts, that on this invention many alterations and changes could be done without abandonning the volume and spirit of the invention.

1. A display/screen for portable electronic devices, comprising two or more individual displays/screens configured to be folded or unfolded.

2. The device of claim 1, wherein an unfolded entire active width of the display/screen is related to an unfolded entire active height of the display/screen by a ratio of 4:3.

3. The device of claim 1, wherein the two or more individual displays/screens can be folded and unfolded along at least one horizontal axis in one complex according to a formula: b=[(a:4)*3}:n; where a=an active width of the individual display/screen, b=an active height of the individual display/screen, and n=the number of individual displays/screens.

4. The device of claim 1, wherein the two or more individual displays/screens can be folded and unfolded along at least one vertical axis in one complex according to a first formula: c=a:n, where c=an active width of the individual display/screen, a=an entire active width of all displays/screens, and n=a number of individual displays/screens, and to a second formula b=(a:4)*3, where b=an active height of the individual display/screen, and a=the entire active width of all displays/screens.

5. The device of claim 1, wherein the two or more individual displays/screens can be folded and unfolded along at least one vertical axis and at least one horizontal axis in one complex according to a formula: (a*n):(b*n)=4:3, where a=an active width of the individual display/screen, b=an active height of the individual display/screen, and n=the number of individual displays/screens.

6. The device of claim 1, wherein at least two of the foldable and unfoldable individual displays/screens are configured to visually present electronic signals, information, pictures or data that are produced, processed, transferred or received by the portable electronic device.

7. The device of claim 6, wherein the electronic signals, information, pictures or data, which are produced, processed, transferred or received by the portable electronic device are divided by hardware or software in as many individual parts of the whole to correspond to the number of individual displays/screens of the device, where each of the divided parts of the totality of the electronic signals, information, pictures or data is presented separately on respective ones of the individual displays/screens.

8. The device of claim 7, wherein the divided electronic signals, information, pictures or data make together a complete presentation of the electronic signals, information, pictures or data in the two or more individual displays/screens.

9. The device of claim 1, wherein at least one of the two or more individual displays/screens comprises an integral portion of the portable electronic device.

10. The device of claim 1, wherein at least one of the two or more individual displays/screens is removably and electrically connectable with the portable electronic device.
